(19) United States
(12) Patent Application Publication
(10) Pub. No.: US 2025/0375795 A1
(43) Pub. Date: Dec. 11, 2025

(54) GARMENT CLASSIFYING AND SORTING SYSTEM AND METHOD

(71) Applicant: THE HONG KONG RESEARCH INSTITUTE OF TEXTILES AND APPAREL LIMITED, Hong Kong (CN)

(72) Inventors: Lei YAO, Hong Kong (CN); Kit-shan NGAN, Hong Kong (CN); Kin-ming LEUNG, Hong Kong (CN); Wui-ka HO, Hong Kong (CN); Zijian MO, Hong Kong (CN); Hung-chiu WU, Hong Kong (CN); Ka-yat WONG, Hong Kong (CN)

(21) Appl. No.: 19/307,596

(22) Filed: Aug. 22, 2025

Related U.S. Application Data
(63) Continuation of application No. PCT/CN2023/078222, filed on Feb. 24, 2023.

(51) Int. Cl. B07C 5/342; B07C 5/36; D06F 93/00

(52) U.S. Cl. CPC B07C 5/3422; B07C 5/362; D06F 93/00; B07C 2501/0063

(57) ABSTRACT

A garment classifying and sorting system and method which sort and classify garments even when the garments are in a relaxed form and arbitrary form, such as when the garment is crumpled, wrinkled or folded.

### CROSS-REFERENCE TO RELATED APPLICATIONS

This application is a continuation of International Application No. PCT/CN2023/078222 with an international filing date of Feb. 24, 2023, designating the U.S., now pending, the entire contents of which are incorporated by reference in this application.

### BACKGROUND OF THE INVENTION

### 1. Field of the Invention

Aspects of this application relate to a garment sorting system and method which sorts and classifies garments even when the garments are in a relaxed form and arbitrary form, such as when the garment is crumpled, wrinkled or folded.

### 2. Description of the Related Art

Present technologies are only able to classify a garment when the garment is worn on a mannequin or in a flat form with the garment features visible and exposed. Present technologies are unable to classify garment types when a garment is in the relaxed and arbitrary form. Currently, the present technologies require each garment to be neatly presented to classify the garment.

### SUMMARY OF THE INVENTION

According to an aspect of the present invention, a customizable garment classifying and sorting system and method use artificial intelligence technology where modules are deployable as stand-alone unit or integrated to perform together to meet business needs. Classifying and sorting garments enable better targeted treatment and recycling results, such that based on various garment characteristics, better methods of decomposition may be applied. In addition, the classifying and sorting of the garments enables the garments to be more easily resold, sold to outside vendors or provided to non-governmental organizations (NGOs) and other interested third parties.

The garment classifying and sorting system includes a garment type classification module, a garment fabric structure classification module, a garment fabric material classification module and garment color classification module. All of the above-mentioned modules can be retrofitted into the existing system with ease. It is contemplated that other modules may be incorporated to classify other characteristics of garments.

According to an embodiment of the present invention, a garment classifying and sorting system includes: a mover module; a garment separating module to separate a garment from a plurality of garments and place on the mover module; at least one database of images or hyperspectral images of parts or pieces of a garment to distinguish a characteristic of a classification of the garment based upon information relating to the parts or pieces of the garment; and at least one garment classification module to detect the characteristic of the classification relating to the parts or pieces of the garment based upon the information.

According to an embodiment of the present invention, a garment classifying and sorting method incudes: separating a garment from a plurality of garments; moving the garment along a path; and detecting, along the path, at least one characteristic of classification relating to parts or pieces of the garment based upon information related to the parts or pieces of the garment stored in at least one database; wherein the at least one database comprises images or hyperspectral images of parts or pieces of garments to distinguish the characteristic of the classification of the garment based upon the information relating to the parts or pieces of the garment.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A, 1B and 1C show a perspective, top and side view, respectively, of a garment classifying and sorting system according to an embodiment of the present invention.

FIG. 2 shows a side view of the garment type classification module of FIGS. 1A, 1B and 1C according to an embodiment of the present invention.

FIG. 3A and FIG. 3B show a side view of the garment fabric structure classification module and a cross-section of a camera module, respectively, of the garment fabric structure classification module of FIGS. 1A, 1B and 1C according to an embodiment of the present invention.

FIGS. 4A and 4B show side views of both the garment fabric material classification module 400 and the color classification module 500 according to an embodiment of the present invention.

FIG. 5A shows a garment that is stretched with the most signature features visible, and FIG. 5B shows a garment in arbitrary form, where only some signature features are visible, according to an embodiment of the present invention.

FIG. 6 is a flowchart showing a simplified version of dataflow for the garment type classification module, the garment fabric structure classification module, the garment fabric material classification module and the garment color classification module, and how they can all come together and reach a central database stage according to an embodiment of the present invention.

FIG. 7 is a flowchart showing data flow for garment type classification and garment fabric structure classification according to an embodiment of the present invention

FIG. 8 is a flowchart showing data flow for garment fabric material classification and garment color classification.

FIG. 9 is a schematic diagram of the central computing device shown in FIG. 1A.

FIG. 10 shows the garment type classification module 200 with additional cameras and illumination elements to be used in a data acquisition stage for building the database for the garment type classification module.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

According to an embodiment of the present invention, a customizable garment sorting system uses artificial intelligence technology where modules are deployable as stand-alone unit or integrated to perform together to meet business needs. Classifying and sorting garments enable better targeted treatment and recycling results, such that based on various garment characteristics, better methods of decomposition may be applied. In addition, the classifying and sorting of the garments enables the garments to be more easily resold, sold to outside vendors or provided to non-governmental organizations (NGOs) and other interested third parties.

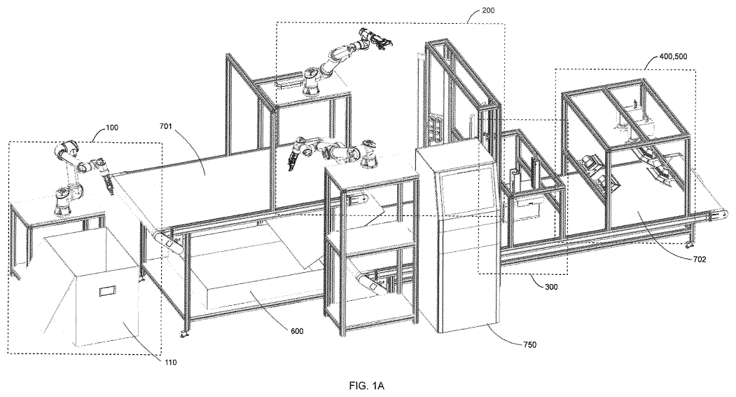

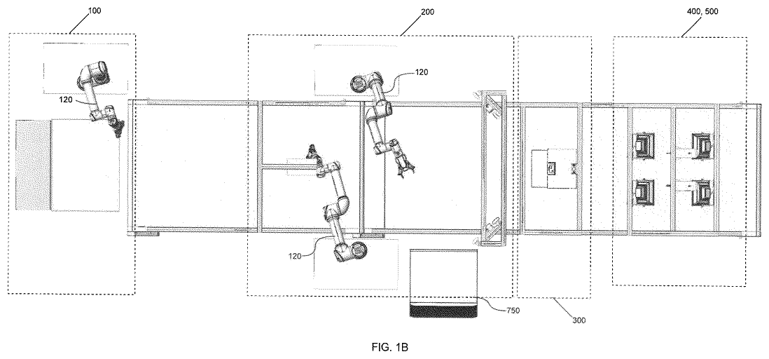

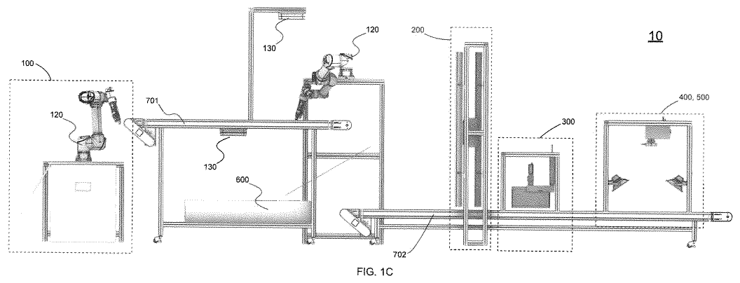

As shown in FIGS. 1A-4B, a garment classifying and sorting system 10 includes a garment type classification module 200, a garment fabric structure classification module 300, a garment fabric material classification module 400 and garment color classification module 500. All of the above-mentioned modules can be retrofitted into an existing classifying and sorting system with ease. It is contemplated that other modules may be incorporated to classify other characteristics of garments.

One feature of the garment classifying and sorting system 10 is that the four modules, the garment type classification module 200, the garment fabric structure classification module 300, the garment fabric material classification module 400 and the garment color classification module 500 can be deployed together or separately in any combination thereof, depending on business needs. By integrating the four modules into the garment classifying and sorting system 10, four different classification results that are useful to recyclers can be generated quickly, within a matter of seconds, with all of the results stored in a database to provide full traceability.

FIGS. 1A, 1B and 1C show a perspective view, a top view and a bottom view, respectively, of the garment classifying and sorting system 10 which includes a garment separating module 100, the garment type classification module 200, the garment fabric structure classification module 300, the garment fabric material classification module 400, the garment color classification module 500, and a garment return module 600.

The garment separating module 100 uses a robotic arm 120 to pick up garments one-by-one from a pile of garments 110 and puts each garment on an infeed conveyor belt 701. The garment separating module 100 and the garment return module 600 are auxiliary modules that help to separate garments one at a time from the pile of garments 110 to achieve full automation and to separate missed garments, respectively. Sometimes the robotic arm 120 might not be able to clamp onto the garment tightly and the garment might drop on its way to the exit conveyor garment return module 600. The garment return module 600 helps to collect these ‘missed’ items and prevents them from dropping on the floor. The classification modules 200, 300, 400 and 500 are able to generate a result if a captured image is input into the trained module, just that it will generate a false result.

A transmission path is used to transport garments from the infeed conveyor 701 of the garment classifying and sorting system 10 to the garment return module 701 of the garment classifying and sorting system passing through all the modules 200, 300, 400, 500 located in different parts of the garment classifying and sorting system 100. The transmission path is subdivided into two conveyor belts, the infeed conveyor belt 701 and an exit conveyor belt 702. The two conveyor belts 701, 702 form a mover module and are arranged in a continuous manner, but the height of the infeed conveyor belt 701 is above that of the exit conveyor belt 702. The garment separating module 100 is located next to the infeed conveyor belt 701. The garment type classification module 200 is located after the garment separating module 100. The garment fabric structure classification module 300 is located at the middle of the exit conveyor belt 702. The garment fabric material classification module garment color classification module 500 are located towards the end of the exit conveyor belt 702. The return module 600 is located below the infeed conveyor belt 701, with a ramp tilted at an angle to facilitate a drop of collected missed garments. A central computing device 750 hosts all the databases and issue commands to the individual modules. The modules 200. 300, 400, 500 may be positioned in any order and any in any combination in the garment classifying and sorting system 10, including as stand-alone modules.

The garment separating module 100 is used for the recycling system to be fully automated as the garment type classification, garment fabric structure classification, garment fabric material classification and garment color classification modules 200, 300, 400, 500 are designed to process one garment at a time. This garment separating module 100 helps to separate garments one at a time from the pile of garments 110.

The garment separating module 100 comprises a robotic arm 120 equipped with a vision system 130 and a built-in KNN classification algorithm.

The built-in KNN classification algorithm processes data (image frames) captured by the vision system 130 and generates an object bounding box according to edges and color of the garments in each image frame. The built-in KNN classification algorithm then transforms the bounding box information into coordinates where the robotic arm 120 performs a grab and hold action. Sensors onboard a gripper of the robotic arm 120 detects whether a grab and hold action is successful. The goal is to separate garment pieces one at a time from the pile 110 of garments and to transfer the garments to the infeed conveyor belt 701.

### Garment Type Classification Module

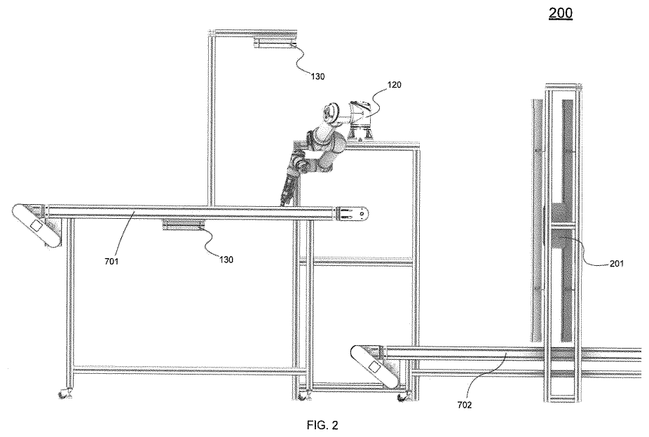

FIG. 2 shows a side view of the garment type classification module 200 which is an automated process unit integrated with a deep learning classification algorithm (802 as shown in FIG. 7), developed to meet the business requirements on classifying garment types.

The garment type classification module 200 accurately classifies many types of commonly seen garments, such as a blouse, a cardigan, a crop-top, a dress, a hat, a hoodie, a jacket, jeans, onesies, overalls, a polo-shirt, a robe, a romper, a scarf, a shirt, shorts, a skirt, a sweater, a tank-top, a tie, trousers, a t-shirt and a vest. It is contemplated that other types of garments may be included as part of the classification process. A database with hundreds of thousands, if not more, images is built to aid the development of the garment type deep learning classification algorithm 802. In this example, 80% of images are used for training, 10% used for validation and 10% used for testing, but any array of percentages may be used to build up the database.

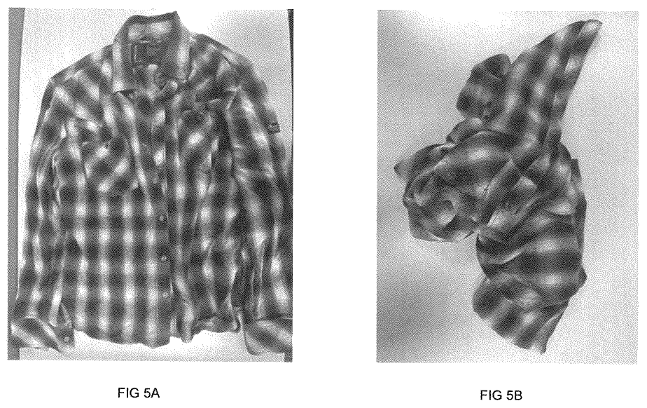

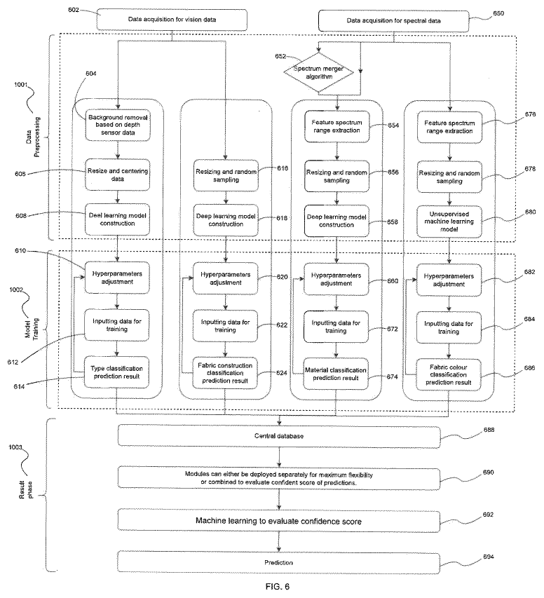

As shown in FIG. 5A, existing technology is only able to classify a garment that is presented in a neat form, stretched out and with all of the garment's characteristics exposed on the surface, whereas the garment type classification module 200 is able to classify garments that are in an arbitrary form, such as when the garment is crumpled, wrinkled or folded, as shown in FIG. 5B.

The garment type classification module 200 includes a camera 201, a deep learning classification algorithm 802 (as shown in FIG. 7) and a central controlling device 750 for running the deep learning classification algorithm and for storing the results.

The garment type classification module 200 can be deployed as a standalone unit or integrated with the other modules mentioned above according to business requirements, creating a mix-and-match model that most suits each individual client's request.

The garment type classification module 200 can be easily retrofitted into existing systems as the garment type classification module 200 is fully functional with the camera 201, the central controlling device 750 that is preloaded with the deep learning classification algorithm 802, and an ethernet cable or other type of connection that connects the camera 201 and the central controlling device 750. The garment type classification module 200 can have a computational device therein which receives the instructions from the central controlling device 750, to control the garment classification module 200. The camera 201 takes an image of parts or pieces of a garment to distinguish a characteristic of a classification of the garment. The camera 201 does not need to take an image of the entire garment.

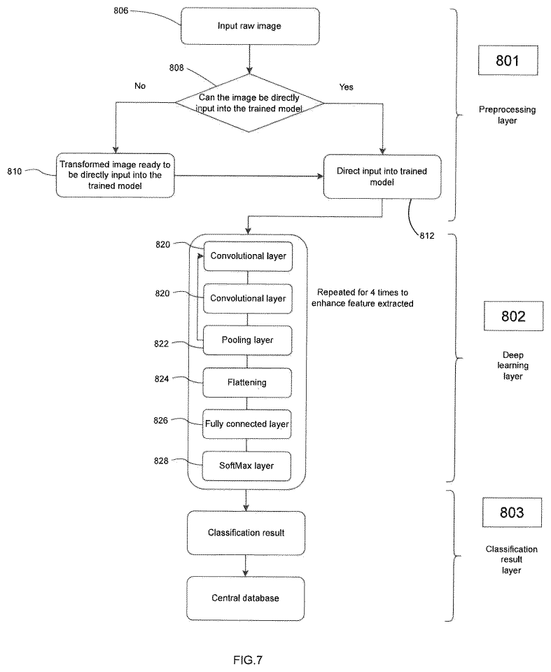

FIG. 6 is a flowchart showing core module relationship and flow of the different modules. All modules include a data pre-processing phase 1001, a model training phase 1002 and a result phase 1003.

Data pre-processing phase 1001 is the stage where raw data is transformed in a way to be best input into the model training. This includes removing irrelevant parts of the data such as background and noise, resizing the data so as to fit the model input size requirements.

The model training phase 1002 is where the deep learning classification model is implemented in a way that most suits the various classification requirements. The deep learning classification layer has several layers. A backbone is open sourced and can be found on standard machine learning libraries such as Tensorflow and Pytorch. The present embodiment incorporates additional layers on top of the backbone to tailor classification and requirements of the user. Hyperparameters are settings in the deep learning classification model that require human input to make sure the deep learning algorithm works as intended, and an example would be adding additional layers, and configuring a correct loss function (a mathematical function used by the model to deduce how correct the results are at a current stage, to help optimize the process).

The result phase 1003 is where results of the different modules result can be combined for additional simple machine learning to evaluate whether the results of the combination makes sense (compatible). For example, since denim is made of cotton and polyester only, if there is a case where the garment type is classified as denim, but the garment fabric material is classified as silk, then the garment classifying and sorting system 10 will raise a flag to alert the user/client. This is also the phase where the result is stored in a central database for history or future use.

As shown in FIG. 6, all the modules 200, 300, 400 and 500 observe similar training steps. All modules 200. 300, 400 and 500 start with data preprocessing 1001, followed by model training 1002, and finally a result phase 1003. Data acquisition is carried out for both vision data 602 and spectral data 650. Data captured using a regular camera is in the form of vision data 602 while data captured using a hyperspectral camera is in a form of spectral data 650. Preprocessing for the vision data 602 includes background removal 604, resize and centering 606, 616 and deep learning model construction 608, 618. While the preprocessing for spectral data might include a spectrum merger algorithm 652 before feature spectrum range extraction 654, 676, resizing and random sampling of the feature spectrum 656, 678, and finally deep learning model construction 658 and building the unsupervised machine learning model 680 are performed. In the model training phase, the preprocessed data is then fed into the model 612, 622, 672, 684 for training. Results are generated for each module. A type classification prediction result 614 will be generated for the type classification module; a garment fabric structure classification prediction result 624 will be generated for the garment fabric structure classification module; a garment fabric material classification prediction result 674 will be generated for the garment fabric material classification module; and a fabric color classification prediction result 686 will be generated for the fabric color classification module. During the training phase, hyperparameters 610, 620, 660, 682 for individual models are adjusted. The result phase is where the trained model is stored in a central database 688 for future deployment. This database 688 is specifically used to store different versions of the trained model for future use. The stored modules can then either be deployed separately or simultaneously according to business needs 690. If multiple modules are deployed simultaneously, their result can be further evaluated by another machine learning algorithm to determine the confidence score 692. A final prediction will then be generated 694.

As noted above, FIG. 6 is a flowchart showing a simplified version of dataflow for the garment type classification module 200, the garment fabric structure classification module 300, the garment fabric material classification module 400 and the garment color classification module 500, and how they can all come together and reach a central database stage in operation 688. Operation 690 shows that if more than one module is used, the result of the deployed modules can then be further feed into a trained model to evaluate whether the resulting combination is normally seen/makes sense (are compatible) (i.e., T shirts normally made from cotton or cotton blended materials, so if the type module generates a T-shirt result, but the material module generate a silk result, the system will then make the user aware of this uncommon combination.

FIG. 7 is a flowchart of the garment type deep learning classification algorithm architecture. A raw image captured by the camera 201 (parts or pieces of a garment to distinguish a characteristic of a classification of the garment).

is input into the pre-processing layer 801 for transformation before entering the deep learning layer 802. Once the image enters the deep learning layer 802, it is passed through multiple convolutional layers 820, a pooling layer 822, a fattening layer 824, a fully connected layer 826, and a softmax layer 828. A confidence score 803 is produced by the deep learning classification algorithm 802 as well as a prediction label (which garment type the model thinks the input image belongs to). The result is then stored in the database to be available for future use. Multiple convolutional layers are used to extract features from an image in a convolutional neural network (CNN).

### Garment Fabric Structure Classification Module

The garment fabric structure classification module 300 is an automated process unit integrated with the deep learning classification algorithm 802 specifically developed to meet the business requirement on classifying garment fabric structure. Backbone architecture and the three stages are basically the same, just the detail preprocessing 801 is done differently.

The garment fabric structure classification module 300 accurately classifies types of commonly seen garments fabric structures, such as knit, woven and non-woven. A database with over 30,000 images (but any number of images is acceptable) is built to aid the development of the garment fabric structure deep learning classification algorithm 802. In this embodiment, 80% the of images are used for training, 10% used for validation and 10% used for testing, but those percentages can be adjusted to any figures.

The garment fabric structure classification module 300 is developed specifically for classifying garment fabric structure of a garment even when the garment surface is not wrinkle-free as shown in FIG. 5B.

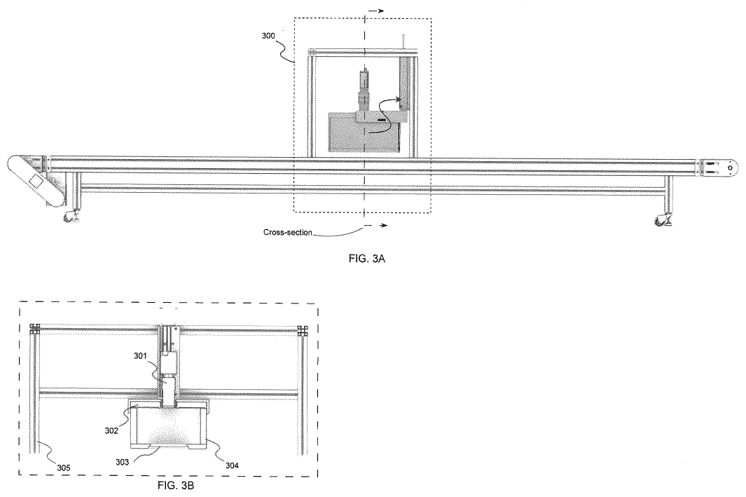

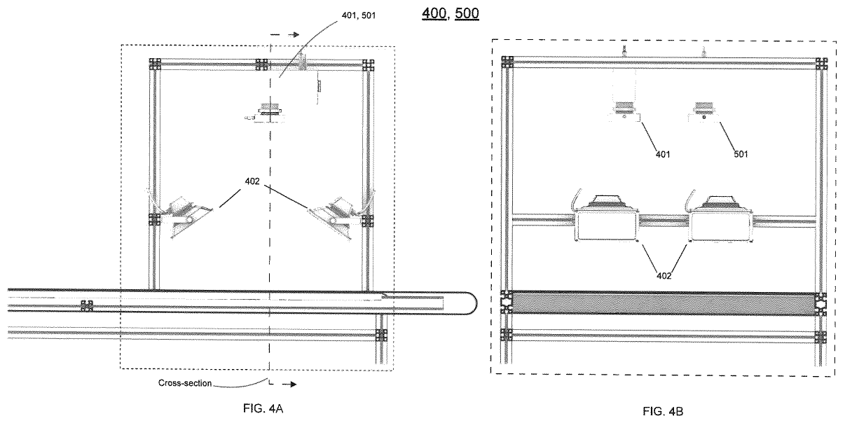

FIG. 3A and FIG. 3B show a side view of the garment fabric structure classification module and a cross-section of a camera module, respectively, of the garment fabric structure classification module 300 of FIGS. 1A, 1B and 1C.

The garment fabric structure classification module 300 includes a macro-camera 301, a motor-driven photobooth 302 with lighting equipment embedded within, a deep learning classification algorithm 802 and in the central controlling device 750. The garment fabric structure classification module 300 can have a computational device therein which receives the instructions from the central controlling device 750, to control the garment fabric structure classification module 300. The results are stored in a database.

The garment fabric structure classification module 300 can be deployed as a standalone unit or integrated with other modules mentioned in this application according to business needs, creating a mix-and-match model that best suits client applications.

Once an optional entry trigger sensor (not shown in the figures) that is embedded on a metal frame 305 detects a garment passing by, the motor-driven photo-booth 302 is lowered to compress a surface of the garment, until the motor-driven photo-booth 301 reaches a traveling distance which will vary according to different types of garments. For instance, a coat will be much thicker than a T-shirt, and thus the motor-driven photo-booth 302 will not need to travel as far to reach the surface of the coat. To ensure the focal distance of the macro-camera 301 is always the same, the macro-camera 301 is mounted on the top of the motor driven photobooth 302 where the focal point will always be on the inner surface of the bottom side of the photo-booth 303. To ensure the capturing of a high-resolution image, the photo-booth side which will come in contact with the garment is replaced with a clear glass panel 303. After the motor-driven photobooth 302 is lowered and slightly compresses (in other words, by way of example, comes into contact with) the target garment underneath, the macro-camera 301 captures the image of an enlarged surface of the garment (parts or pieces of the garment) to distinguish a characteristic of a classification of the garment. The camera 301 does not need to take an image of the entire garment.

and feeds the image into the garment fabric structure deep learning classification algorithm 802.

The garment fabric structure classification module 300 can be easily retrofitted into existing systems as the garment fabric structure classification module 300 is already fully functional with the following components: a macro-camera 301, a motor driven photobooth 302, the central controlling unit 750 that is preloaded with the deep learning classification algorithm 802, and an ethernet cable or other connection that connects the macro-camera 301 with the computational device. The garment fabric structure classification module 300 can have a computational device therein which receives the instructions from the central controlling device 750 to control the garment fabric structure classification module 300.

The garment fabric structure deep learning classification algorithm architecture is outlined in FIG. 7. A raw image captured by the macro-camera 301 is input into a pre-processing layer 801 for transformation before entering the deep learning layer 802. Once the image enters the deep learning layer, it is passed through multiple convolutional layers 820, a pooling layer 822, a fattening layer 824, a fully connected layer 826, and a softmax layer. A confidence score 803 will be produced by the deep learning classification algorithm as well as the prediction label (which garment type the model thinks the input image belongs to). The result is then stored in the database to be available for future use. The data is essentially in the same form, just that one belongs to the garment fabric structure module 300 and one belongs to garment type classification module 200, i.e., the garment fabric structure module 300 might be (knit: 0.98, woven: 0.01, non-woven: 0.01) while the garment type classification module 200 result might be (coat: 0.98, denim: 0.02, etc.). The decimal numbers are probabilities.

The parameters, i.e., brightness, exposure, gain, of the macro-camera 301 are pre-set to achieve optimal captures for both dark and bright colored garments.

### Garment Fabric Material Classification Module and the Garment Color Classification Module

FIG. 4A and FIG. 4B show side views of both the garment fabric material classification module 400 and the garment color classification module 500. A hyperspectral camera 401 for the garment fabric material classification module 400 (fx17e in this case) and a hyperspectral camera 501 for the garment color classification module (fx10e in our case) both share the same set of halogen lighting system 402 (although this does not have to be the case), and both hyperspectral cameras 401, 501 are placed side by side. Fx17e and Fx10e look the same and are both hyperspectral cameras, just that they focus on different ranges on the spectrum (Fx17e on 900-1000 nm; Fx10e on 400-1000 nm range).

The garment fabric material composition module 400 and the garment color classification module 500 actually use different cameras, but they are both hyperspectral cameras (fx17e for fabric material classification in our case and fx10e for color classification). Hyperspectral cameras have strict requirements on the lighting source (since hyperspectral camera data accuracy relies a significant amount of lighting reflectance). Therefore, in FIGS. 4A and 4B, the hyperspectral cameras 401 and 501 are placed next to each other so that only one set of halogen lighting system 402 is needed.

If both modules (classification) are needed due to business needs, then two hyperspectral cameras (501 which is 400-1000 nm and 401 which is at 900-1700 nm) will be mounted on the same metal frame, side by side. However, if only one of the modules is needed (say just fabric material classification), then it is possible for only the 900-1700 nm hyperspectral camera 401 to be mounted on the metal frame. Since both modules use a hyperspectral camera to capture data and given the strict lighting conditions required for hyperspectral camera operation, this embodiment uses an integrated halogen lighting system 402 if both modules (garment fabric material classification module 400 and garment color classification module 500) are integrated at the same time, in other words they share the same lighting conditions. However, in other embodiments, if only one of the two modules is needed, then one of the hyperspectral cameras is not mounted on the metal frame. Also, according to another embodiment, the garment fabric classification module 400 and the garment color classification 500 and their corresponding hyperspectral cameras 401, 501 are mounted on separate metal frames.

As noted above, FIGS. 4A and 4B show side views of the garment fabric material composition classification module 400 which performs an automated process unit integrated with a deep learning classification algorithm 902 developed to meet the business requirements on classifying garment fabric material composition.

The garment fabric material composition classification module 400 accurately classifies many different compositions of commonly seen garments, such as cotton, polyester, nylon, wool, leather, viscose, spandex, acrylic, rayon, silk and also blended materials. Other types of material composition classifications may be used according to this and other embodiments. A database with hyperspectral images is built to aid the development of the garment fabric material deep learning classification algorithm 902. 80% of images are used for training, 10% used for validation and 10% used for testing, but any other range of percentages may be used.

The garment fabric material composition classification module 400 is developed for predicting garment fabric material composition by analyzing 900-1700 nm spectrum data captured by the hyperspectral camera 401.

Hyperspectral camera sensors embedded in the hyperspectral cameras 401, 501 look at objects using a vast portion of the electromagnetic spectrum. Certain garment fabric materials leave unique ‘fingerprints’ in the electromagnetic spectrum. Known as spectral signatures, these ‘fingerprints’ enable identification of the materials of the garment. The hyperspectral cameras 401, 501 take a hyperspectral image of parts or pieces of a garment to distinguish a characteristic of a classification of the garment. The cameras 401, 501 does not need to take an image of the entire garment.

Conventional garment fabric material composition classification systems suffer from a drawback on predicting garment fabric material composition of darker colored garments, but the garment fabric material composition classification module 400 is able to overcome this setback by taking into account a reflective intensity as an input feature to the deep-learning model 902. During the training of the fabric material and color deep learning model, we are aware that garments with the exact same content might have a different reflective intensity due to the color of the garment, i.e., a dark color garment will have a lower reflective intensity than a light color garment as more light is adsorbed. Thus, the correlation of dark color garments with its corresponding spectrum is determined and included as an input during model training. Most of the time, existing devices are unable or inaccurate to classify the dark color garment.

As shown in FIGS. 4A and 4B, the garment fabric material composition classification module 400 includes the hyperspectral camera 401 that is able to read the 900-1700 nm wavelength region, the halogen light system 402, a garment fabric material composition deep learning classification algorithm 902 and the central controlling device 750 for running the deep learning classification algorithm 902 and for storing the results. The garment fabric material classification module 400 can have a computational device therein which receives the instructions from the central controlling device 750, to control the garment fabric material classification module 400.

The garment fabric material composition classification module 400 can be easily retrofitted into existing systems as the garment fabric material composition classification module 400 is fully functional with the following components: the hyperspectral camera 401 that is able to read the 900-1700 nm wavelength region, the halogen light system, the garment fabric material composition deep learning classification algorithm 902 and the central controlling device 750 for running the deep learning classification algorithm 902 and for storing the results.

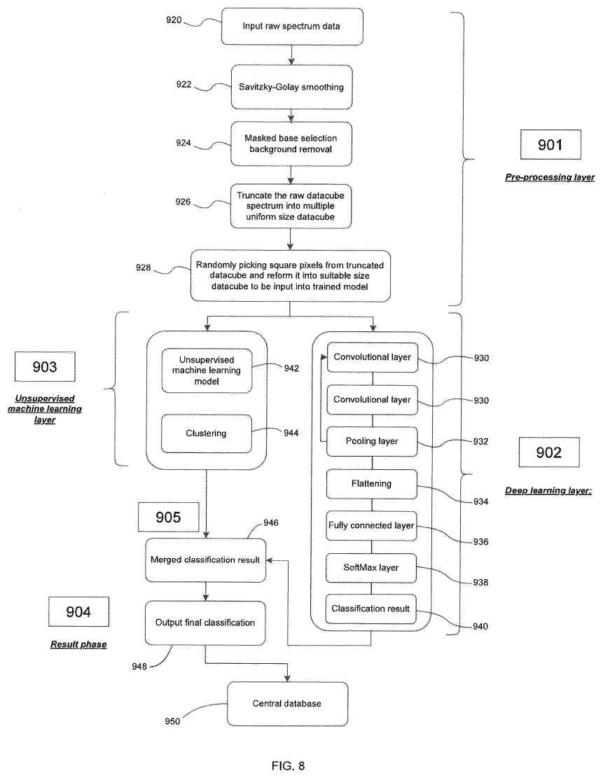

The garment fabric material composition classification algorithm 902 architecture is outlined in FIG. 8. A raw hyperspectral image captured by the 900-1700 nm spectrum range hyperspectral camera 401 is input 920 into a pre-processing layer 901 for transformation before entering the deep learning layer 902. Since the data format for the garment fabric material composition classification algorithm and the garment color classification algorithm are similar/same, the pre-processing tasks are highly similar. Raw spectrum data 920 is first normalized using the smoothing techniques, such as but not limited to Savitzky-Golay smoothing 922. The background noise of the spectrum data 920 is then removed using a mask-based selection technique 924. Since the raw spectrum data is usually very large, it is truncated into multiple uniform sizes and stored in the form of a datacube 926. Random square pixels are then picked from the datacube 926 to reform an even smaller dimension datacube that can be input into the training model 928. Transformed garment fabric material data will then be passed through the deep learning layer 902 while transformed garment color data will be passed through an unsupervised machine learning layer (algorithm) 903. The training result from the deep learning layer 902 and unsupervised machine learning layer 903 can be merged 905 together to generate a final classification result. The result will then be stored in a central database 950 for future use.

Since the raw spectrum data is usually very large, it is truncated into multiple uniform sizes in data cube format 926 for easier processing at the classification deep learning phase. By way of example, the original spectrum 920 size is 1200×640, first resize (926) this original 1200×640 spectrum into a smaller square size 256×256 (928), and then this square is further resized into 224×224 by randomly choosing data from the 256×256.

Once the pre-processed hyperspectral image enters the deep learning layer 902, it is passed through multiple convolutional layers 930, a pooling layer 932, a flattening layer 934, a fully connected layer 936, and a softmax layer 938. A confidence score will be produced by the deep learning classification algorithm as well as the prediction label 940 (which garment fabric material the model thinks the input image belongs to). The result is then stored in the database 950 to be available for future use. The steps 942, 944 belong to the garment color classification. Both the fabric material and color classifications share highly similar pre-processing stages. It is just that after the preprocessing layer 901, the algorithm training steps are different. Hence for operations 902 and 903, step 946 is for merging the result from the garment material classification module 400 (the right path) and the garment color classification module 500 (the left path).

The garment fabric material classification result can be merged with the garment color classification result in step 946 (which will be mentioned in the following section) for easy management or future machine learning application.

The garment fabric material composition classification module 400 can be deployed as a standalone unit or integrated with other modules mentioned in this application according to business requirements, creating a mix-and-match model that best suits a client's needs.

### Garment Color Classification Module

The garment color classification module 500 shown in FIGS. 4A and 4B is an automated process unit integrated with a deep learning classification algorithm 903 as shown in FIG. 8, specifically developed to meet the business requirements on classifying garment color.

The garment color classification module 500 accurately classifies commonly seen garment colors, such as black, blue, white, yellow, green, red, brown, purple and marginal colors (i.e., greenish blue). It is envisioned that any other color classification may be incorporated into this embodiment. A database with thousands, if not more, hyperspectral images is built to aid the development of the garment color deep learning classification algorithm 903. 80% of images are used for training, 10% used for validation and 10% used for testing, although any other percentages are contemplated.

The garment color classification module 500 is developed specifically for classifying garment color by analyzing the 400-1000 nm spectrum data captured by the hyperspectral camera 501.

Sensors of the hyperspectral camera 501 look at objects, in this case the garments, using a vast portion (any limits to the term “vast” of the electromagnetic spectrum. Certain garment fabric materials leave unique ‘fingerprints’ in the electromagnetic spectrum. Known as spectral signatures, these ‘fingerprints’ enable identification of the materials of the garment. Since both the garment color classification module 500 and garment fabric material classification module 400 use hyperspectral cameras, the working principle is the same. They work by recognizing fingerprints on the spectrum. Just that fx10e covers the 400-1000 nm range while fx17e covers the 900-1700 nm range.

Conventional garment color classification systems suffer from the drawback of predicting garment fabric material color of darker color garments, but the garment color classification module 500 is able to overcome this setback by taking into account the reflective intensity as an input feature to the unsupervised machine learning layer (algorithm) 903.

As noted above, the garment fabric material classification module 400 and the garment color classification module 500 both use hyperspectral cameras 401, 501 to collect data, and it is just that the garment fabric material classification module 400 uses the hyperspectral camera 401 that is able to read to the 900-1700 nm range, while the garment color identification module 500 uses the hyperspectral camera 501 that is able to read the 400-1000 nm range.

The garment color classification module 500 can be easily retrofitted into existing systems as the garment fabric material composition classification module is fully functional with the following components: hyperspectral camera 501 that is able to read the 400-1000 nm wavelength region, the halogen lighting system 402, a garment color unsupervised machine learning layer 903 and the central controlling unit for running the unsupervised machine learning algorithm 942 and 944 and for storing the results in a central database 950. The garment color classification module 500 can have a computational device therein which receives the instructions from the central controlling device 750, to control the garment color classification module 500

The garment color classification algorithm architecture is outlined in FIG. 8. A raw hyperspectral image captured by the 400-1000 nm spectrum range hyperspectral camera 501 is input into a pre-processing layer 901 for transformation before entering the unsupervised machine learning layer 903.

The pre-processing layer 901 in FIG. 8 includes steps including inputting raw spectrum data 920, Savitzky-Golay (just one example of a type of smoothing) smoothing 922 to normalize the raw spectrum data, as well as masked base selection background removal 924 to enhance training data quality. Since the raw spectrum data is usually very large, it is truncated into multiple uniform sizes in data cube format 928 for easier processing at the unsupervised machine learning layer 903.

Once the pre-processed hyperspectral image enters the unsupervised machine learning layer 942 of 903, it is passed into a clustering algorithm 944 to classify the garment color. A confidence score is produced by the unsupervised machine learning layer as well as the prediction label (which garment color the model thinks the input image belongs to). The result is then stored in the database to be available for future use.

The garment color classification result from step 944 can be merged with the garment fabric material classification result 940 (which is mentioned in the previous section) in step 946 to output a final classification 948 for easy management or a future machine learning application.

The garment color classification module 500 can be deployed as a standalone unit or integrated with other modules mentioned in the above embodiments according to business requirements, creating a mix-and-match model that most suit client application. The garment fabric material and color classification algorithms can be totally separated. But since both material and color classification modules 400, 500 use a hyperspectral camera, meaning their data format are the same, the data can be merged (400-1000 nm for color and 900-1700 nm for material merged together and get the result is 400-1700 nm).

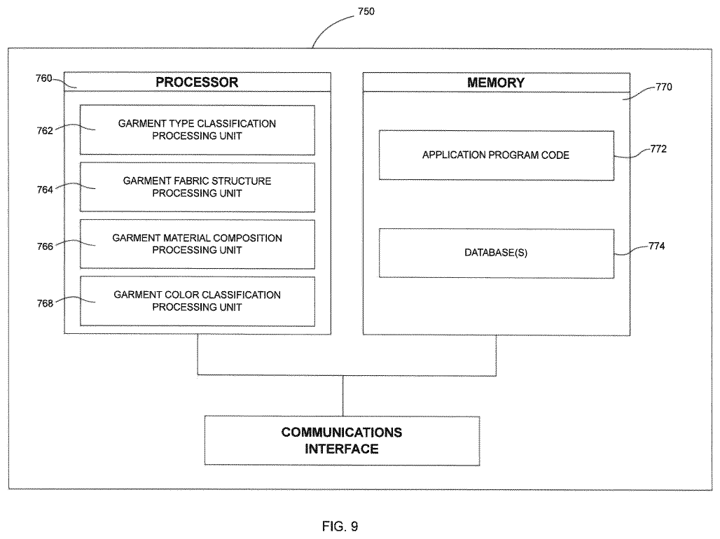

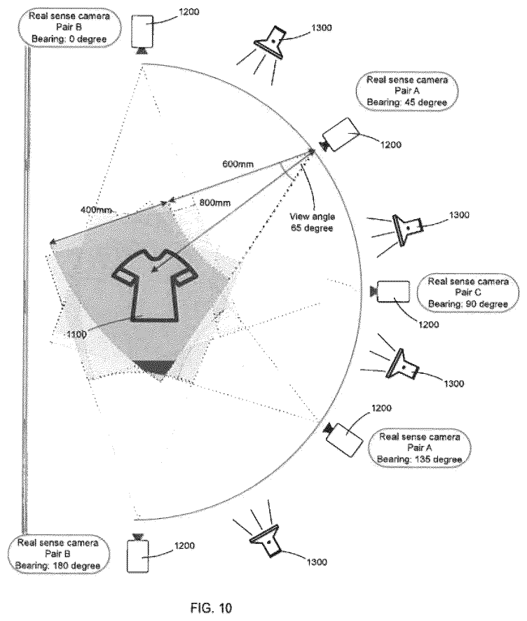

FIG. 9 is a schematic diagram of the central computing device 750 shown in FIG. 1A according to an embodiment of the present invention. As shown in FIG. 9, the central computing device 750 includes at least one processor 760, at least one memory 770, and at least one communications interface 780. The processor 12, the memory 14, and the communications interface 13 are connected and communicate with each other through a communications bus.

The processor 760 may be a general-purpose central processing unit (CPU), implemented by at least one of electronic units such as an application-specific integrated circuit (ASIC), one or more integrated circuits, a digital signal processor (DSP), a programmable logic device (PLD), a field programmable gate array (FPGA), a processor, a controller, a microcontroller, and/or a microprocessor, or may be implemented by a software module that performs at least one function or operation.

The communications interface 780 is configured to communicate with other elements of the central computing device 750 as well as other elements of the garment classifying and sorting system 10, through a wire and/or wireless connection, and may be configured to communicate with communications networks, such as the Ethernet, a radio access network (RAN), or a wireless local area network (WLAN).

The memory 770 (a non-transitory computer readable medium) may be a read-only memory (ROM) or another type of static storage device that can store static information and an instruction, a random access memory (RAM) or another type of dynamic storage device that can store information and an instruction, or may be an electrically erasable programmable read-only memory (EEPROM), a compact disc read-only memory (CD-ROM) or another compact disc storage, an optical disc storage (including a compact disc, a laser disc, an optical disc, a digital versatile disc, a Blu-ray disc, or the like), a magnetic disk storage medium or another magnetic storage device, or any other medium that can be used to carry or store expected program code in a form of an instruction or a data structure and that can be accessed by a computer. However, the memory 770 is not limited thereto. The memory may exist independently and is connected to the processor 760 by using the communications bus. Alternatively, the memory 770 may be integrated with the processor 760.

The memory 770 is configured to store application program code for executing the foregoing and following methods and processes, and the processor 760 controls the execution thereof. The processor 760 is configured to execute the application program code 772 stored in the memory 770. The memory 770 also includes at least one database 774 to store the information related to the data gathered by the garment type classification module 200, the fabric structure classification module 300, the garment fabric material composition module 400 and the garment color classification module 500.

The processor 760 includes a garment type classification processing unit 762, a garment fabric structure classification processing unit 764, a garment fabric material composition processing unit 766 and a garment color classification processing unit 768. The a garment type classification processing unit 762 processes the information related to the elements and data gathering of the garment type classification module 200, determines the results of the garment type classification and interacts with the memory 770. The garment fabric structure classification processing unit 764 processes the information related to the elements and data gathering of the garment fabric structure module 300, determines the results of the garment fabric structure classification and interacts with the memory 770. The garment fabric material composition processing unit 766 processes the information related to the elements and data gathering of the garment fabric material composition classification module 400, determines the results of the garment fabric material composition classification and interacts with the memory 770. The garment color classification processing unit 768 processes the information related to the elements and data gathering of the garment color classification module 500, determines the results of the garment color classification and interacts with the memory 770. The above processing units also may interact with each other.

It should be noted that the processor 760 may be physically located in one location or multiple locations, as is the case with the memory 770 and the communications interface 780, and is not limited to a single location or device as shown in FIG. 1A with respect to the central control device 750.

Aspects of this application relate to a garment sorting system which sorts and classifies garments even when the garments are in a relaxed form and arbitrary form, such as when the garment is crumpled, wrinkled or folded.

Thus, as noted above, present technologies are only able to classify a garment when the garment is worn on a mannequin or in a flat form with the garment features visible and exposed. Present technologies are unable to classify garment types when a garment is in the relaxed and arbitrary form. Currently, the present technologies require each garment to be neatly presented to classify the garment.

FIG. 10 shows the garment type classification module 200 with additional cameras and illumination elements to be used in a data acquisition stage for building the database for the garment type classification module. In this data acquisition stage, at least two cameras 1200 are used to capture a garment 1100 image from different angle(s) simultaneously. Illumination elements 1300 are interspersed between the cameras 1200 to provide illumination. The cameras may be spread out in a half circle, partially surrounding the garment This type of imaging ensures that all the characteristic features, such as but not limited to, a collar, a sleeve and cuffs from a shirt are visible and captured. Images with exposed features of a same type of garment will then be grouped together, preprocessed 801 and fed into the deep learning layer 802 in batches to facilitate the training process.

In a data acquisition stage for building the garment fabric structure classification module 300, at least one macro camera 301 is used to capture characteristics features of different garment fabric structures. Images with exposed fabric structure features of the same type will then be grouped together, preprocessed 801 and fed into the deep learning layer 802 in batches to facilitate the training process.

In the data acquisition stage for building the garment material classification module 400, the hyperspectral camera 401 that covers the 900-1700 nm range is used to capture the spectrum data of a garment on a pixel level. Garment materials that are alike are then grouped together, preprocessed and fed into the deep learning layer 902 in batches to facilitate the training process.

In the data acquisition stage for building the garment color classification module 500, the hyperspectral camera 501 that covers the 400-1000 nm range is used to capture the spectrum data of a garment on a pixel level. The data captured is then fed simultaneously into an unsupervised machine learning layer 903 for clustering. Commonly seen colors, such as blue, red and orange will be included.

A sorting module is in place to sort the garments according to the result previously generated from the classification modules 200, 300, 400, 500 previously. A transmission path is in place to divert each garment into a suitable container. The diversion might be guided, but not limited to, pneumatics components or mechanical components to the suitable container.

The deep learning layer uses multilayer neural network to automatically learn the image and extract the deep-seated features of the image. The same includes multiple filter layers that execute a layer-by-layer propagation to extract high level features (sleeve, cuff, collar) from low level features (curves, corners, lines and dots) in the example of a T-shirt (parts or pieces of the garment). Thus, images of parts or pieces of a garment can be used to distinguish a characteristic of a classification of the garment, so that classifications can be made even when a garment is in arbitrary form, such as when the garment is wrinkled or crumpled. The camera 201 does not need to take an image of the entire garment.

Convolutional neural network (CNN) algorithms are constructed capable of extracting garment image features and making classifications. The convolutional layers are deployed for automatically extracting features, which executes layer-by-layer propagation to generate high-level features from low-level features. The pooling layers reduce the dimensionality of the convolutional features to facilitate reduction in computational complexity. The fully connected layers connect all features extracted from the convolutional layers, applies linear transformation and nonlinear activation to produce the final outputs of overall garment classifications. The garment samples are identified to be the corresponding garment classifications with the largest probability values.

According to embodiments of the present invention, a customizable garment classifying and sorting system and method use artificial intelligence (deep learning) technology where modules are deployable as stand-alone unit or integrated to perform together to meet business needs. Classifying and sorting garments enable better targeted treatment and recycling results, such that based on various garment characteristics, better methods of decomposition may be applied. In addition, the classifying and sorting of the garments enables the garments to be more easily resold, sold to outside vendors or provided to non-governmental organizations (NGOs) and other interested third parties.

The garments, when being classified, may be in an arbitrary form, such as when the garment is crumpled, wrinkled or folded, so that the garment does not have to be stretched out, flat, or hung up, such as on a mannequin. Images of parts or pieces of a garment can be used to distinguish a characteristic of a classification of the garment. Images of an entire garment are not necessary.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A garment classifying and sorting system comprising:
a mover module;
a garment separating module to separate a garment from a plurality of garments and place on the mover module;
at least one database of images or hyperspectral images of parts or pieces of a garment to distinguish a characteristic of a classification of the garment based upon information relating to the parts or pieces of the garment; and
at least one garment classification module to detect the characteristic of the classification relating to the parts or pieces of the garment based upon the information.

2. The garment classifying and sorting system according to claim 1, wherein:
the at least one database comprises at least one of the following:
a first database of images of parts or pieces of the garment to distinguish a garment type based upon information relating to the parts or pieces of the garment;
a second database of images of parts or pieces of the garment to distinguish a garment fabric structure based upon information relating to the parts or pieces of the garment;
a third database of hyperspectral images of parts or pieces of the garment to distinguish a garment material composition based upon information relating to the parts or pieces of the garment; or
a fourth database of hyperspectral images of parts or pieces of the garment to distinguish a garment color based upon information relating to the parts or pieces of the garment; and
the at least one garment classification module comprises at least one of the following:
a garment type classification module to detect characteristic features relating to the parts and pieces of garment types and using a deep-learning algorithm to classify the garment type of the garment based upon the information stored in the first database;
a garment fabric structure classification module to detect characteristic features relating to the parts and pieces of the garment related to garment fabric structure, and using a deep-learning algorithm to classify the garment fabric structure based upon the information in the second database; and
a garment fabric material classification module to detect characteristic features relating to the parts and pieces of the garment related to garment fabric material, and using a deep-learning algorithm to classify the garment fabric material based upon the information in the third database; or
a garment color classification module to detect characteristics features relating to the parts and pieces of the garment relating to garment color, and using an unsupervised machine learning algorithm to classify the garment color based on the information in the fourth database.

3. The garment classifying and sorting system according to claim 2, wherein:
the at least one database comprises a plurality of the first through fourth databases; and
the at least one garment classification module comprises a plurality of the garment type classification module, the garment fabric structure classification module, the garment structure classification module or the garment color classification module.

4. The garment classifying and sorting system according to claim 2, wherein:
the at least one database comprises the first through fourth databases; and
the at least one garment classification module comprises the garment type classification module, the garment fabric structure classification module, the garment structure classification module and the garment color classification module.

5. The garment classifying and sorting system according to claim 2, wherein:
the garment type classification module comprises:
a camera to take an image of a part or piece of the garment; and
a processor to compare the image to the images of the first database to determine a type of the garment.

6. The garment classifying and sorting system according to claim 2, wherein:
the garment fabric structure classification module comprises:
a motor driven photobooth;
a macro camera mounted on the motor driven photobooth; and
a processor to move the motor driven photobooth towards the garment so that the motor driven photobooth comes into contact with the garment to compress the garment, and to have the macro camera take an enlarged image of the part or piece of the garment;
wherein the processor compares the enlarged image to the images of the second database to determine a fabric structure of the garment.

7. The garment classifying and sorting system according to claim 2, wherein:
the garment fabric material classification module comprises:
a halogen light system to illuminate the garment;
a hyperspectral camera focusing in a range of 900-1000 nm to take an image of a part or piece of the garment; and
a processor to compare the image to the images of the third database to determine a fabric material of the garment.

8. The garment classifying and sorting system according to claim 2, wherein:
the garment color classification module comprises:
a halogen light system to illuminate the garment;
a hyperspectral camera focusing in a range of 400-1000 nm to take an image of a part or piece of the garment; and
a processor to compare the image to the images of the fourth database to determine a color of the garment.

9. The garment classifying and sorting system according to claim 2, wherein:
the garment fabric material classification module comprises:
a halogen light system to illuminate the garment;
a first hyperspectral camera focusing in a range of 900-1000 nm to take an image of a part or piece of the garment; and
a processor to compare the image to the images of the third database to determine a fabric material of the garment; and
the garment color classification module comprises:
the same halogen light system as that in the garment fabric material classification module to illuminate the garment;
a second hyperspectral camera focusing in a range of 400-1000 nm to take an image of a part or piece of the garment; and
a processor to compare the image to the images of the fourth database to determine a color of the garment.

10. The garment classifying and sorting system according to claim 2, wherein
the garment separating module comprises a robotic arm to separate the garment from the plurality of garments; and
the mover module comprises:
a first conveyor to move the separated garment to the at least one garment classification module; and
a return module to return the separated garment to the plurality of garments or elsewhere when the separated garment is unclassifiable by the at least garment classification module.

11. The garment classifying and sorting system according to claim 10, wherein a second conveyor is below the first conveyor so that the second conveyor receives the separated garment as the separated garment falls from the first conveyor.

12. The garment classifying and sorting system according to claim 3, wherein the garment type classification module further comprises:
at least two additional cameras spaced apart from each other and which simultaneously capture images of parts or pieces of a garment during a database building stage to gather multiple characteristic features of the garment used for the database building stage to be fed to a deep learning layer to facilitate a training process.

13. The garment classifying and sorting system according to claim 2, further comprising a processor to combine at least two of the garment type, garment fabric structure, garment fabric material and garment color classifications of the garment.

14. The garment classifying and sorting system according to claim 2, wherein:
the garment fabric material classification module takes into account a reflective intensity due to a color of the garment as an input feature to the deep learning algorithm; and
the garment color classification module takes into account the reflective intensity due to a color of the garment as an input feature to the unsupervised machine learning algorithm.

15. The garment classifying and sorting system according to claim 7, wherein the hyperspectral camera captures spectrum data of the garment on a pixel level.

16. The garment classifying and sorting system according to claim 8, wherein the hyperspectral camera captures spectrum data of the garment on a pixel level.

17. A garment classifying and sorting method, being applied to the garment classifying and sorting system according to claim 1, the method comprising:
separating a garment from a plurality of garments;
moving the garment along a path; and
detecting, along the path, at least one characteristic of classification relating to parts or pieces of the garment based upon information related to the parts or pieces of the garment stored in at least one database;
wherein the at least one database comprises images or hyperspectral images of parts or pieces of garments to distinguish the characteristic of the classification of the garment based upon the information relating to the parts or pieces of the garment.

18. The garment classifying and sorting method according to claim 17, wherein:
the at least one database comprises at least one of the following:
a first database of images of parts or pieces of the garment to distinguish a garment type based upon information relating to the parts or pieces of the garment;
a second database of images of parts or pieces of the garment to distinguish a garment fabric structure based upon information relating to the parts of pieces of the garment;
a third database of hyperspectral images of parts or pieces of the garment to distinguish a garment material composition based upon information relating to the parts or pieces of the garment; or
a fourth database of hyperspectral images of parts or pieces of a garment to distinguish the garment color based upon information relating to the parts or pieces of the garment; and
the detecting, along the path, at least one characteristic of classification relating to parts or pieces of the garment comprises:
at least one of the following:
detecting characteristic features relating to the parts and pieces of garment types and using a deep-learning algorithm to classify the garment type of the garment based upon the information stored in the first database;
detecting characteristic features relating to the parts and pieces of the garment related to garment fabric structure, and using a deep-learning algorithm to classify the garment fabric structure based upon the information in the second database;
detecting characteristic features relating to the parts and pieces of the garment related to garment fabric material, and using a deep-learning algorithm to classify the garment fabric material based upon the information in the third database; or
detecting characteristics features relating to the parts and pieces of the garment relating to garment color, and using an unsupervised machine learning algorithm to classify the garment color based on the information in the fourth database.

19. The garment classifying and sorting method according to claim 18, wherein the: detecting, along the path, at least one characteristic of classification relating to parts or pieces of the garment comprises:
at least one of detecting a garment type classification, a garment fabric structure classification, a garment structure classification or garment color classification of the garment.

20. The garment classifying and sorting method according to claim 18, wherein the detecting, along the path, at least one characteristic of classification relating to parts or pieces of the garment comprises:
detecting a garment type classification, a garment fabric structure classification, a garment structure classification and a garment color classification of the garment.
